(19) United States
(12) Patent Application Publication
(10) Pub. No.: US 2003/0020768 A1
(43) Pub. Date: Jan. 30, 2003

(54) Direct write TM system

(76) Inventor: Michael J. Renn, Albuquerque, NM (US)

Correspondence Address: PEACOCK MYERS AND ADAMS P C, P O BOX 26927, ALBUQUERQUE, NM, 871256927

(21) Appl. No.: 10/060,960

(22) Filed: Jan. 30, 2002

Related U.S. Application Data
(60) Provisional application No. 60/102,418, filed on Sep. 30, 1998.

(30) Foreign Application Priority Data
May 30, 2001 PCT/US01/14841

(51) Int. Cl. B41J 3/00

(52) U.S. Cl. 347/2

(57) ABSTRACT

Methods and apparatus for the deposition of a source material (10) are disclosed. An atomizer (12) renders a supply of source material (10) into many discrete particles. A force applicator (14) propels the particles in continuous, parallel streams of discrete particles. A collimator (16) controls the direction of flight of the particles in the stream prior to their deposition on a substrate (18). In an alternative embodiment of the invention, the viscosity of the particles may be controlled to enable complex depositions of non-conformal or three-dimensional surfaces. The invention also includes a wide variety of substrate treatments which may occur before, during or after deposition. In yet another embodiment of the invention, a virtual or cascade impactor may be employed to remove selected particles from the deposition stream.

### CROSS-REFERENCES TO RELATED PATENT APPLICATIONS & CLAIMS FOR PRIORITY

The Applicant hereby claims the benefit of priority under Sections 119 & 120 of Title 35 of the United States Code of Laws for any and all subject matter which is commonly disclosed in the present application and in:

U.S. patent application Ser. No. 60/102,418, filed on Sep. 30, 1998 entitled Laser-Guided Manipulation of Non-Atomic Particles by Michael J. Renn et al.;

PCT International Patent Application Number PCT/US99/22527, filed on Sep. 30, 1999 entitled Laser-Guided Manipulation of Non-Atomic Particles by Michael J. Renn et al.;

U.S. patent application Ser. No. 09/408,621, filed on Sep. 30, 1999 entitled Laser-Guided Manipulation of Non-Atomic Particles by Michael J. Renn et al.;

U.S. patent application Ser. No. 09/584,997 filed on Jun. 1, 2000 and entitled Particle Guidance System by Michael J. Renn; and

PCT International Patent Application No. PCT/US01/10841 filed on May 30, 2001 and entitled Particle Guidance System by Michael J. Renn et al.

### FEDERALLY SPONSORED RESEARCH OR DEVELOPMENT

The Invention described below was developed using funds from Government Contract No. N00014-99-C-0243 issued by the U.S. Office of Naval Research. Under the terms of the Contract, the Contractor and Assignee, the Optomec Design Company, of Albuquerque, N.Mex., retains rights in the Invention in accordance with Section 52.227-11 of the Federal Acquisition Regulations (Patent Rights-Retention by Contractor, Short Form).

### FIELD OF THE INVENTION

The present invention relates generally to the field of precisely depositing a selected material on a substrate. More specifically, one embodiment of the present invention relates to methods and apparatus for generating discrete particles from a source material, creating parallel streams of discrete particles, and then guiding them onto a substrate to form a planar, conformal or three-dimensional feature on the substrate.

### BACKGROUND OF THE INVENTION

Many industrial processes require the formation of layers of a material on a substrate or base. These processes include Ink Jet Printing, Photolithography and DuPont's Fodel® technology.

Ink Jet Printing

Ink jet printing is one well-known process that can be used to apply a layer of one material on a substrate. In most cases, inkjet printing is employed to place tiny droplets of ink onto a sheet of paper to create text or an image.

One kind of ink jet printer employs “thermal bubble” or “bubble jet” technology, in which ink is heated in a print head that includes hundreds or nozzles or orifices. The high levels of heat generated by resistors built into the print head vaporize the ink, and forms a series of single bubbles of ink which are propelled out of the nozzles toward a sheet of paper. In another kind of inkjet printing, an array of piezo-electric crystals is activated to vibrate and expel ink from a corresponding array of nozzles.

Both types of ink jet printers are remarkably accurate. A typical ink jet print head has 300 to 600 nozzles, and can form dots of many different colors of ink that are as small as 50 microns in diameter. All of the nozzles can be activated at once to produce complex applications of ink on paper that can even approach or match the resolution of conventional silver halide photography.

Although ink jet printing offers a relatively versatile and inexpensive process for applying a material to a substrate, ink jet printing is generally limited to placing exceedingly thin layers of ink on paper or cloth which are essentially two-dimensional. The viscosity ranges for inkjet printing are limited to ranges of one to ten cp. This limited range of viscosity in turn limits the variety of materials which may be deposited.

Photolithography

Photolithography is a purely planar process that is typically used in the semiconductor industry to build sub-micron structures. Photolithography may be used to build features in the 1˜100-micron range, but is plagued by many severe limitations:

1) The thickness of the features ranges from 0.01 to 1 microns. As a result, mechanical connections may not be made to layer built using a photolithographic layer.

2) The photolithographic process is purely planar. Photolithographic structures formed on a substrate do not include three-dimensional features having a height of more than one micron.

3) Photo lithographical processes, which use a process of vaporization of the deposited metal, needs to be run in a vacuum chamber at a temperature which supports the high temperature required to vaporize the metal.

4) Finally, photolithography requires a mask.

Fodel® Materials

According to the DuPont Corporation, Fodel® materials incorporate photosensitive polymers in a thick film. Circuit features are formed using UV light exposure through a photomask and development in an aqueous process. Fodel® dielectrics can pattern 75 micron vias on a 150 micron pitch, and Fodel® conductors can pattern 50 micron lines on a 100 micron pitch. Fodel® materials extend the density capability of the thick film process to allow densities typically achievable using more costly thin film processes.

Fodel® is a process in which a thick film is placed on the substrate. A mask is then used to expose areas of the thick film to cure the material. The substrate is then chemically etched to remove the uncured material. The Fodel® process can be performed in an ambient environment. The limitations to Fodel® are:

1) The Fodel® process is purely planar. No three-dimensional features can be produced.

2) The Fodel® process uses a chemical etching process which is not conducive to all substrates.

3) Like photolithography, the Fodel® requires a mask.

4) The material costs of the Fodel® process are relatively high.

5) The Fodel® process is limited to features larger than 50 microns.

Other techniques for directing a particle to a substrate involve the use of lasers to create optical forces to manipulate a source material. “Optical tweezers” allow dielectric particles to be trapped near the focal point of a tightly focused, high-power laser beam. These optical tweezers are used to manipulate biological particles, such as viruses, bacteria, micro-organisms, blood cells, plant cells, and chromosomes.

In their article entitled Inertial, Gravitational, Centrifugal, and Thermal Collection Techniques, Marple et al. disclose techniques which may be used to collect particles for subsequent analysis or for particle classification.

TSI Incorporated describes how a virtual impactor works on their website, www.tsi.com.

Another method for applying a source material to a substrate is described in a co-pending and commonly-owned U.S. patent application Ser. No. 09/584,997 filed on Jun. 1, 2000 and entitled Particle Guidance System by Michael J. Renn. This Application discloses methods and apparatus for laser guidance of micron-sized and mesoscopic particles, and also furnishes methods and apparatus which use laser light to trap particles within the hollow region of a hollow-core optical fiber. This invention enables the transportation of particles along the fiber over long distances, and also includes processes for guiding a wide variety of material particles, including solids and aerosol particles, along an optical fiber to a desired destination.

The co-pending Application by Renn describes a laser beam which is directed to an entrance of a hollow-core optical fiber by a focusing lens. A source of particles to be guided through the fiber provides a certain number of particles near the entrance to the fiber. The particles are then drawn into the hollow core of the fiber by the focused laser beam, propagating along a grazing incidence path inside the fiber. Laser induced optical forces, generated by scattering, absorption and refraction of the laser light by a particle, trap the particle close to the center of the fiber and propels it along. Virtually any micron-size material, including solid dielectric, semiconductor and solid particles as well as liquid solvent droplets, can be trapped in laser beams, and transported along optical fibers due to the net effect of exertion of these optical forces. After traveling through the length of the fiber, the particles can be either deposited on a desired substrate or in an analytical chamber, or subjected to other processes depending on the goal of a particular application.

The problem of providing a method and apparatus for optimal control of diverse material particles ranging in size from individual or groups of atoms to microscopic particles used to fabricate articles having fully dense, complex shapes has presented a major challenge to the manufacturing industry. Creating complex objects with desirable material properties, cheaply, accurately and rapidly has been a continuing problem for designers. Producing such objects with gradient or compound materials could provide manufacturers with wide-ranging commercial opportunities. Solving these problems would constitute a major technological advance, and would satisfy a long felt need in the part fabrication industry.

### SUMMARY OF THE INVENTION

The Direct Write™ System provides a maskless, mesoscale deposition device for producing continuous, collimated, parallel streams of discrete, atomized particles of a source material which are deposited on a substrate. Unlike ink jet printers and conventional photolithographic deposition equipment, the present invention can manufacture planar, conformal or three-dimensional surfaces. One embodiment of the present invention is extremely accurate, being capable of using 1 μm droplets to form features as small as 3 μm. The invention is also capable of delivering one billion particles per second to a substrate at scan rates of one meter per second. In addition to being able to deposit a wide variety of inorganic materials such as metals, alloys, dielectrics and insulators. The present invention may also be used to manipulate oraganic and biological entities in droplets such as enzymes, proteins and viruses.

In an alternative embodiment, the invention may also comprise a virtual or cascade impactor to remove selected particles from a stream of gas to enhance deposition.

An appreciation of other aims and objectives of the present invention may be achieved by studying the following description of preferred and alternate embodiments and by referring to the accompanying drawings.

### A BRIEF DESCRIPTION OF THE DRAWINGS

FIG. 1 is a schematic depiction of one of the preferred embodiments of the present invention, which utilizes an energy source and a flow of gas to direct particles toward a substrate.

FIG. 2 is a schematic illustration of an alternative embodiment of the invention, which includes a hollow core optical fiber.

FIG. 3 reveals some details of an aerosol chamber, which is used to create discrete particles of a source material.

FIG. 4 portrays a compressed air jet.

FIG. 5 offers another view of one of the preferred embodiments of the invention.

FIG. 6 supplies a schematic depiction of cascade impaction.

FIG. 7 provides a schematic view of a virtual impactor, while FIG. 8 shows virtual impactors in series.

FIG. 8 supplies a view of particle sorting at an atomization unit and virtual impactors in series.

### A DETAILED DESCRIPTION OF PREFERRED & ALTERNATIVE EMBODIMENTS

I. Direct Write™ Methods & Apparatus

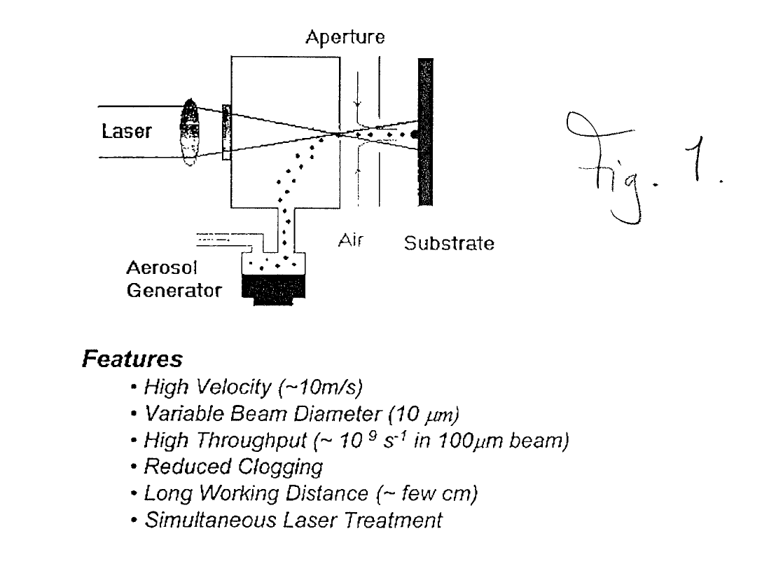

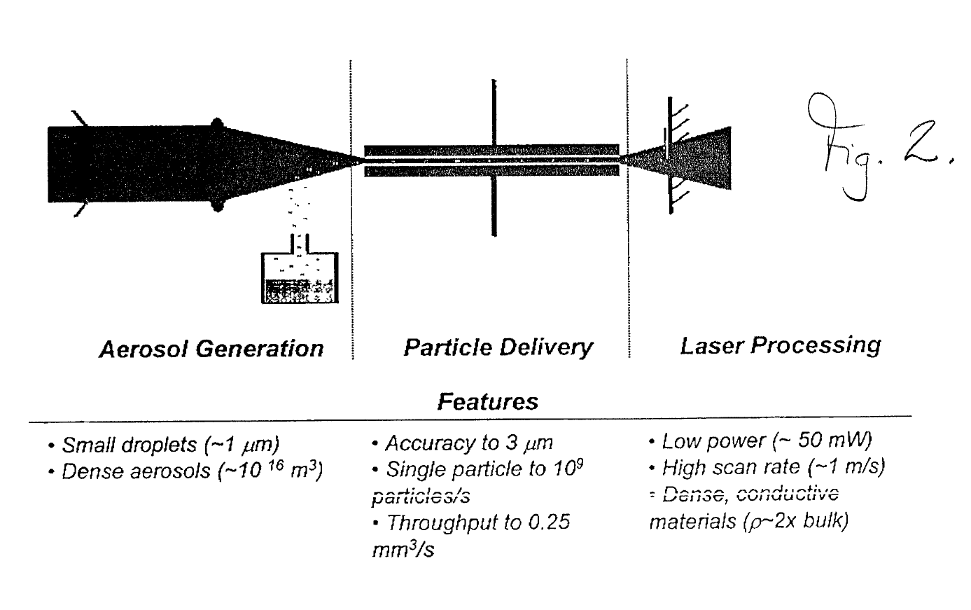

FIG. 1 presents a a schematic view of one of the preferred embodiments of the Direct Write™ System, which comprises methods and apparatus for maskless, mesoscale deposition of a source material on a substrate. Unlike many previous deposition systems which are restricted to the formation of planar layers on a flat substrate, the present invention is capable of forming a wide variety of planar, non-planar, conformal or three-dimensional features on a substrate having virtually any profile or topography.

In one embodiment, the invention comprises a source of material 10 contained by an enclosure 11. Although the a preferred embodiment generally includes a source material in liquid form, the source may comprise any aggregation, mixture, suspension or other combination of any materials in any physical phase. The source of material 10 is contained in a vessel, pool, volume or chamber which is coupled to or in communication with an atomizer 12. In general, the atomizer 12 is responsible for reducing or dividing the source material into discrete particles. The size of the discrete particles may be controlled by the interaction of the physical properties of the source material and/or the atomizer. Any device or means which forms relatively smaller particles from larger particles, from a reservoir of fluid, or from a solid mass may function as the atomizer 12. In this Specification and in the claims that follow, the term “particle” generally refers to discrete portions of a material or materials which have been rendered from a more extensive supply. Various embodiments of the invention, the atomizer 12 may comprise a device that utilizes an ultrasound or pneumatic device, or that employs a spray process, forms an aerosol or condenses particles from a vapor.

The invention includes some means to apply force 14 to the discrete particles of source material 10 which are produced by the atomizer 12. One of the preferred embodiments of the invention utilizes a carrier gas as a force application means to propel the particles. The typical carrier gas flow rates range from one to ten liters per minute. The preferred type of carrier gas is a gas which does not react adversely to the material which is deposited on the substrate. Nitrogen, argon and helium are excellent carrier gases.

FIG. 1 exhibits another embodiment of the invention, which employs a laser and a lens 14 to direct optical energy into a cloud of discrete particles produced by the atomizer 12. This optical energy propels the particles in a desired direction of flight.

Alternative embodiments may incorporate some other energy source to apply force to the particles. Any device which imparts energy to control the direction and speed of the particles could be used in the invention, including devices which generate heat or which produce electromagnetic or other fields that are capable of controlling a stream of particles.

In addition to a means to apply force 14 to the discrete particles, the invention utilizes some means of collimation 16 to control, regulate or limit the direction of flight of the discrete particles. In one embodiment, a hollow column of co-flowing air surrounds the stream of particles, forming a barrier or sheath of gas 16 that guides the particles as they travel from the force application means 14 toward a substrate 18. This collimating gas 16 exerts radial forces on the stream of particles to restrict and focus their movement toward the substrate 18. The sheath gas stream may be produced from a pressurized system. The sheath gas moves through a nozzle that is specifically designed to entrap and focus the gas stream which carries the particles. Different geometric designs of the sheath gas orifices enable larger or smaller deposition areas.

In alternative embodiments of the invention, the collimation means 16 may comprise an aperture in a thin sheet, or a hollow core optical fiber.

In this Specification and in the claims that follow, the term “substrate” refers to any surface, target or object which the particles strike or on which they are deposited. The substrate may be flat or generally planar, or may be characterized by a complex three-dimensional profile. In the various embodiments of the invention, the Direct Write™ apparatus may utilize a deposition assembly which moves over a stationary substrate, or may employ a deposition assembly which remains fixed while the substrate moves.

The invention may be used to deposit on virtually any substrate material. In specific embodiments of the invention, the substrate material comprises green tape ceramic, printed circuit boards, MEMS, flexible circuits formed on Kapton™ or Mylar™, clothes fabrics, glass or biologic materials.

The present invention offers a superior deposition device compared to prior, conventional techniques such as ink jet printing. The Direct Write™ System provides a versatile tool for a wide variety of industrial and biomedical applications, and offers the following highly beneficial features:

Maskless

Performed in an Ambient Environment

Three-Dimensional or Conformal:

Manufacture Features having Depth of 1˜100 Microns

High Velocity (10 μm/s)

Variable Beam Diameter (10 μm)

High Throughput (˜10⁹ s⁻¹ in 100 μm beam)

Reduced Clogging

Long Working Distance (˜few cm)

Deposition of Materials with Viscosities Ranging from 1˜10,000 cp

Simultaneous Laser Treatment

Unlike ink jet print heads, which produce droplets one at a time to produce a single serial stream of droplets from each print head orifice, the Direct Write™ System is capable of producing continuous, parallel streams of discrete particles for deposition. By controlling the viscosity of the atomized particles, the present invention is capable of depositing three-dimensional features which adhere to the substrate without running. The viscosity may be controlled by thinning the material with a solvent, by changing the fundamental design of the material, or by changing the temperature of the material or of the chamber containing the particles. In an optional feature of the invention, the particles may undergo a physical or chemical change before deposition to enhance the characteristics of the final deposited material on the substrate.

A heating process may be employed to change the physical properties of the material. In one embodiment, drops of solvent which hold the particles of material to deposit are removed.

The present invention also provides benefits which are not achievable by photolithographic processes, which require expensive masks which are hard to change, and which are limited to a flat substrate. One embodiment of the invention may be implemented at a relatively low range of temperatures.

The present invention is capable of depositing materials at room temperature. Many of these materials can cure at room temperature. One advantage offered by the invention is the ability to lay down materials in the mesoscopic range (from 1 to 100 microns). If the material needs a thermal post treatment, the deposition can be followed with a laser treatment. The laser beam provides a highly localized thermal and photonic treatment of the material. The laser beam is capable of treating only the deposited material after deposition without affecting the underlying substrate.

The deposition process may involve multiple layers of source material, or may involve immiscible materials. Unlike other previous deposition systems, the present invention may be practiced in an uncontrolled atmosphere.

Unlike some other previous deposition devices, the present invention allows for a variety of substrate treatments during the deposition process. Alternative embodiments of the invention include capabilities for heating the substrate by laser illumination or by increasing the ambient temperature. The substrate may also be cooled during deposition by reducing ambient temperature. Other alternative treatment steps may include photoactivation with a laser, irradiation with infrared light, or illumination with an arc lamp. Another substrate treatment comprises a washing or rinsing process.

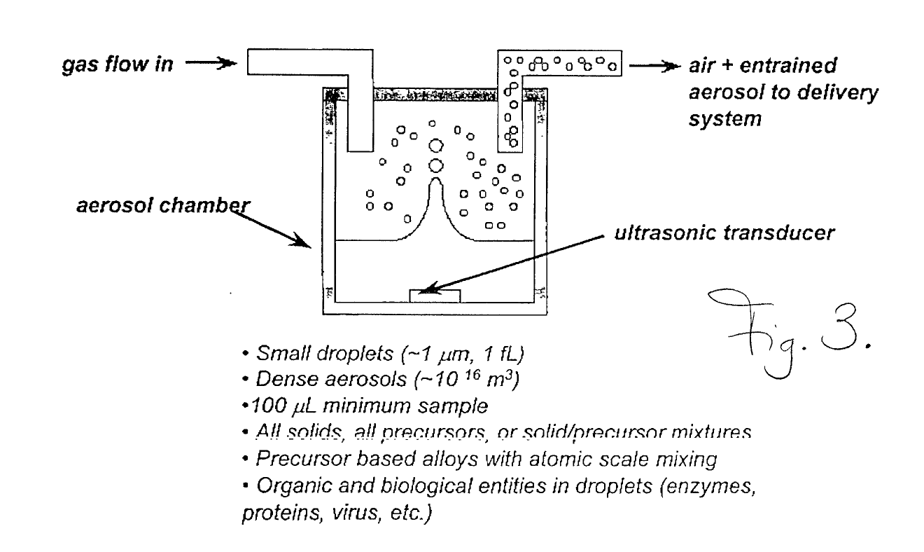

FIG. 2 is a schematic illustration of an alternative embodiment of the invention, which includes a hollow core optical fiber.

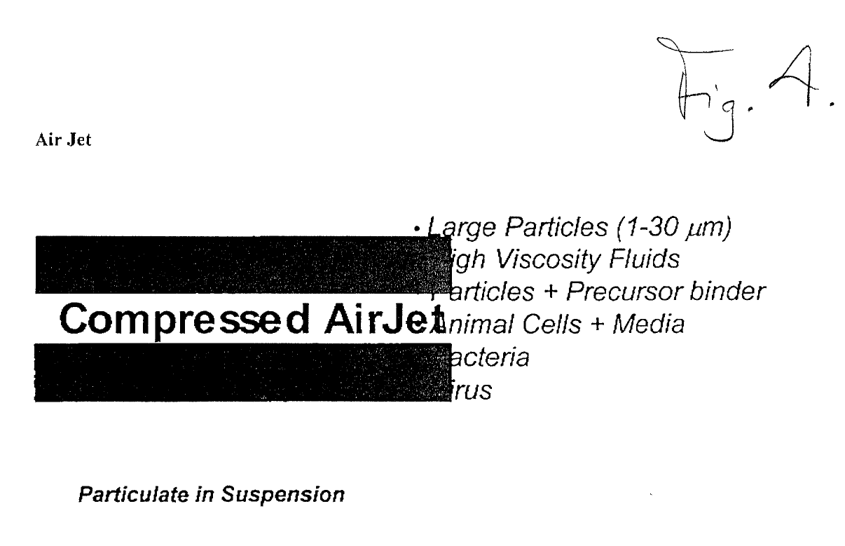

FIG. 3 reveals some details of an aerosol chamber, which is used to create discrete particles of a source material.

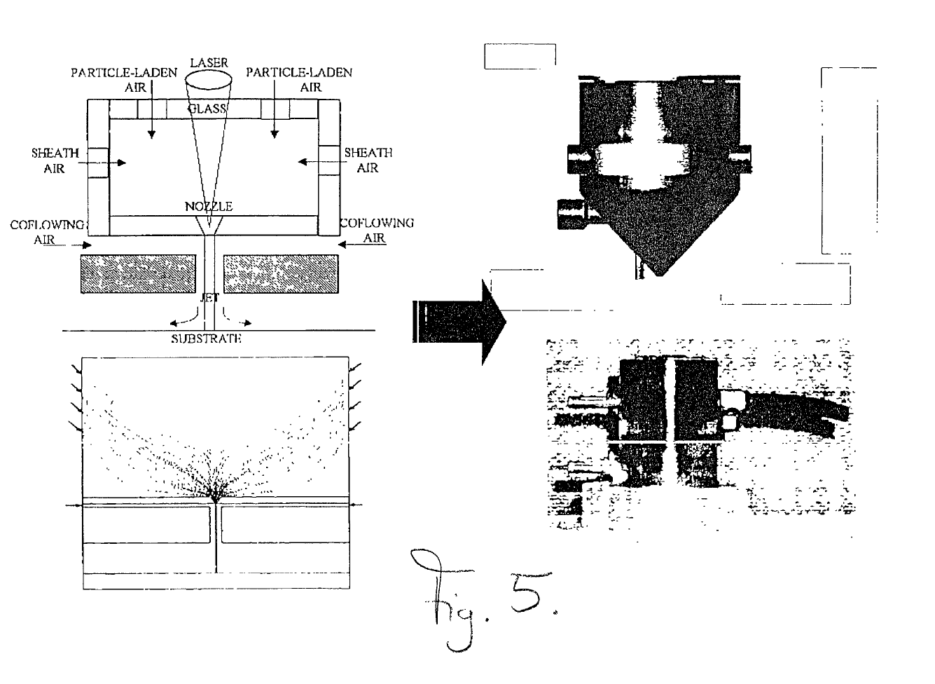

FIG. 4 portrays a compressed air jet.

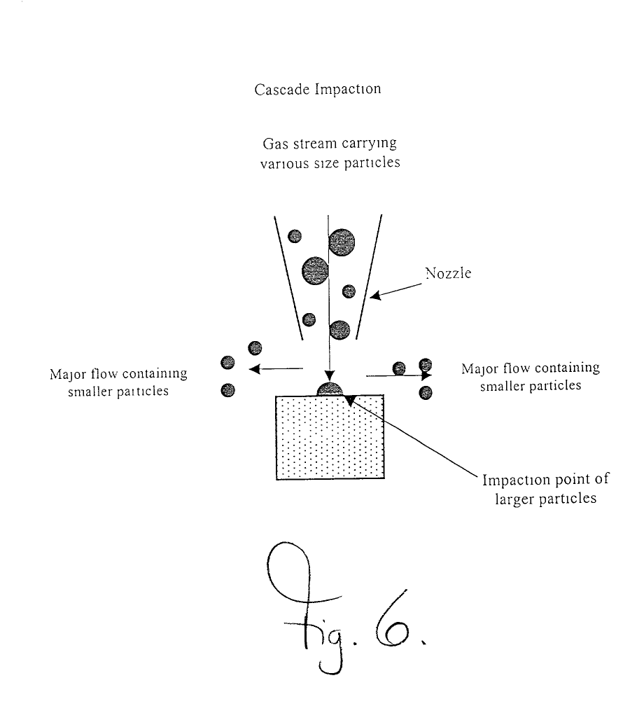

FIG. 5 offers another view of one of the preferred embodiments of the invention.

Precursors

The present invention also offers the ability to simultaneously deposit solid particles and liquid “precursors,” where the liquids serve to fill the gaps between solid particles. In general, a precursor is any material that can be decomposed thermally or chemically to yield a desired final product. Coalescence of liquid precursors on the substrate and subsequent decomposition by laser heating to form a final product on the substrate and sintering of the deposited material by laser, or chemical binding are additional techniques made possible by the invention. A number of precursor and particulate materials may be used to create composite structures having gradient chemical, thermal, mechanical, optical and other properties.

II. Removal of Particles from a Stream of Gas

There are several well-known technologies that involve the removal of particles from a stream of gas. Two of the more common methods are known as cascade impaction and virtual impaction. The most widely used are the inertial classifiers.

Cascade Impaction

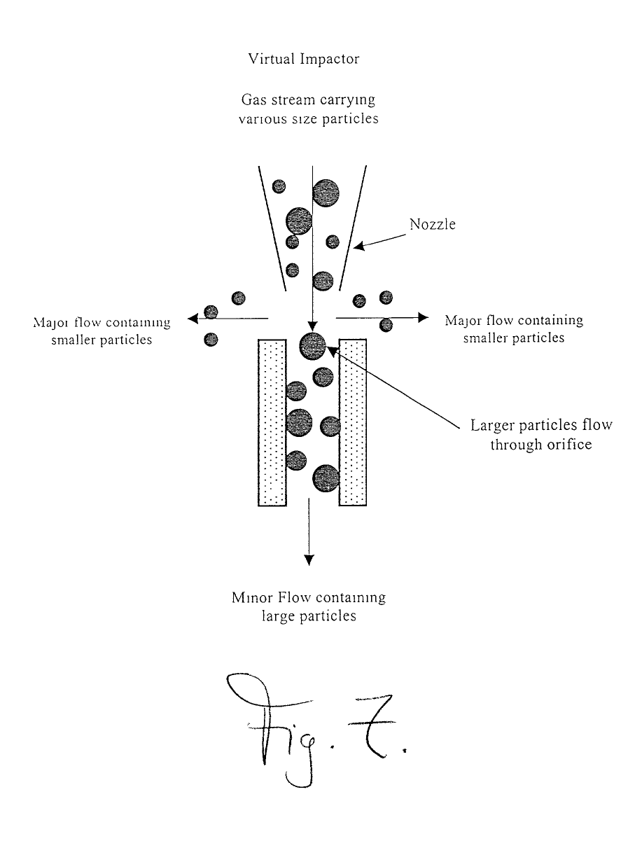

Cascade impaction is a method which may be used to sort larger particles from smaller ones. FIG. 6 presents a pictorial description of the cascade impaction method. A gas stream is produced to carry particles of material of varying size and mass. This gas stream is projected through a nozzle towards an impaction plate. In a steady state condition, the gas produces streamlines above the impaction plate. Particles with larger mass and greater momentum are projected through these streamlines, and strike the impaction plate directly. These particles accumulate on the surface of the impaction plate. Particles with smaller mass and less momentum are carried in the streamlines, and generally do not strike the impactor plate. These smaller particles continue to travel in the gas stream commonly know as the “major flow.”

By optimizing the geometry of the nozzle and impaction plate relative to the gas stream, a method to sort large particles from small ones may be implemented using the cascade impactor. The smaller particles may be collected, or utilized in a down stream process. As shown in FIG. 6, the larger particles are “lost” from the gas stream as they accumulate on the surface of the impactor plate. These larger particles can not be utilized in any down stream processes.

Virtual Impaction

The larger particles may be utilized by employing virtual impaction. Virtual impaction uses the same principles as cascade impaction, except that an orifice allows the larger particles to continue down stream.

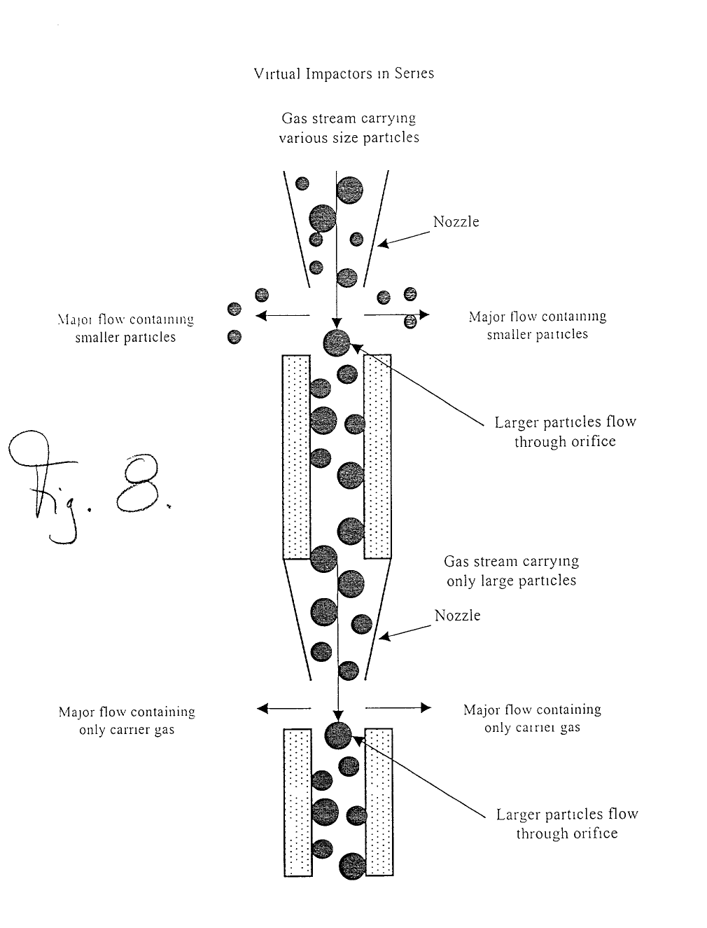

FIG. 7 supplies a schematic view of a virtual impactor. The fundamental difference between a cascade and virtual impactor is that the larger particles are preserved in the gas stream using the virtual impactor.

Applications of Virtual and Cascade Impaction

These two impaction methods were developed for the spraying of particles without any consideration to the density or number of particles in the gas stream. If small particles are desired, then a cascade impactor may be used to eliminate the large particles. If large particles are desired, then a virtual impactor may be used to eliminate the small particles. Typical uses of cascade and virtual impactors arc particle size sorting and sampling.

Gas Removal Process

The present invention enables the direct write of most electronic materials (conductors, resistors, dielectrics). In this application, an atomizer emits a gas stream laden with various size particles. The gas stream from the atomizer flows at the rate of approximately 5 liters per minute. This gas stream flows through a virtual impactor, which strips off 4.95 liters per minute of gas. The remaining gas stream ultimately flows through the deposition head at a rate of 0.050 liters per minute. In this process, it is desirable to strip off only gas, and have the electronic component particles generated at the atomizer be contained in the flow which ultimately impacts the substrate. The highest possible number of particles in the gas stream is the most desirable. The gas stream density can be defined as the number of particles within a given volume of gas.

Gas Stream Density=Number of Particles/Unit of Carrier Gas

In this equation, the number of particles is determined by the atomization method. Once this method is selected, the number of particles generated is fairly constant and cannot be dramatically increased. To increase the gas stream density, it is desirable to remove excess gas from the carrier stream without removing the deposition particles. Stripping off excess gas while carrying the same number of particles would increase the particle density.

The present invention includes several methods to increase the gas stream density.

Method One—A Series of Virtual Impactors

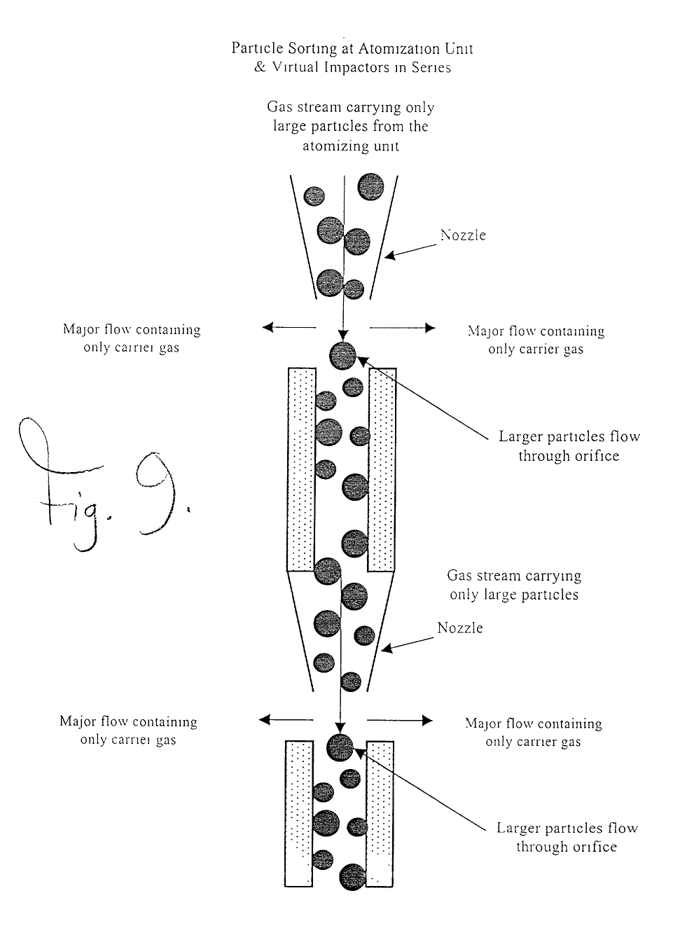

FIG. 8 shows one method of densifying the gas stream. The first method involves placing a number of virtual impactors in series to strip off the excess gas. The first impactor strips off both carrier gas and the smaller particles. The second virtual impactor (and any number after) strips off only carrier gas. In this method, a series of virtual impactors can be used to densify the gas stream by stripping off more and more of the carrier gas.

Method Two—Particle Sorting at the Atomizing Unit

FIG. 9 shows a second method to density the gas stream. This method employs a virtual impactor at the exit of the atomizing unit. This impactor would be used to sort the particle stream prior to introduction into the gas stripping virtual impactors. Essentially, all of the particles in the gas stream would be sized to permit a direct pass through each virtual impaction stage.

### CONCLUSION

Although the present invention has been described in detail with reference to particular preferred and alternative embodiments, persons possessing ordinary skill in the art to which this invention pertains will appreciate that various modifications and enhancements may be made without departing from the spirit and scope of the claims that follow. The various configurations that have been disclosed above are intended to educate the reader about preferred and alternative embodiments, and are not intended to constrain the limits of the invention or the scope of the claims. The List of Reference Characters which follows is intended to provide the reader with a convenient means of identifying elements of the invention in the Specification and Drawings. This list is not intended to delineate or narrow the scope of the claims.

### LIST OF REFERENCE CHARACTERS

10 Source material

11 Enclosure

12 Atomizer

14 Force application means

16 Collimation means

18 Substrate

What is claimed is:

1. An apparatus comprising:
a material source means for supplying a material to be deposited;
an atomization means for producing a plurality of discrete particles from said material source means;
a force application means for propelling said plurality of discrete particles generally toward a substrate;
a collimation means for controlling the direction of flight of said plurality of discrete particles; and
depositing said plurality of discrete particles on said substrate.
